(19) United States
(12) Patent Application Publication
(10) Pub. No.: US 2026/0312027 A1
(43) Pub. Date: Oct. 8, 2026

(54) SECONDARY BATTERY

(71) Applicant: MURATA MANUFACTURING CO., LTD., Kyoto (JP)

(72) Inventor: Kei HASEGAWA, Kyoto (JP)

(21) Appl. No.: 19/462,316

(22) Filed: Jan. 28, 2026

Related U.S. Application Data
(63) Continuation of application No. PCT/JP2024/026496, filed on Jul. 24, 2024.

(30) Foreign Application Priority Data
Sep. 15, 2023 (JP) 2023-150370

(51) Int. Cl. H01M 4/525; H01M 4/02; H01M 4/36; H01M 10/0566

(52) U.S. Cl. CPC H01M 4/525; H01M 4/366; H01M 10/0566; H01M 2004/021; H01M 2004/028

(57) ABSTRACT

A secondary battery is provided and including a positive electrode active material composite containing a positive electrode active material containing an oxide containing Li and Co, and two or more coating layers at least partially covering the positive electrode active material, in which the two or more coating layers include a first coating layer and a second coating layer from the positive electrode active material side toward the outside, one of the first coating layer and the second coating layer includes Al element, and the other of the first coating layer and the second coating layer includes at least one element selected from the group consisting of F, Mg, Mn, and Ti.

### CROSS REFERENCE TO RELATED APPLICATIONS

The present application is a continuation of International Patent Application No. PCT/JP2024/026496, filed on Jul. 24, 2024, which claims priority to Japanese Patent Application No. 2023-150370, filed on Sep. 15, 2023, the entire contents of which are incorporated herein by reference.

### BACKGROUND

The present disclosure relates to a secondary battery.

Conventionally, a secondary battery that can be repeatedly charged and discharged has been used for various applications. For example, secondary batteries are used as power supplies for electronic devices such as smart phones and notebook computers.

A secondary battery has a structure in which an electrode assembly including a positive electrode, a negative electrode, and a separator disposed between the positive electrode and the negative electrode, and an electrolyte solution are housed in an exterior body. The positive electrode includes a positive electrode material layer containing a positive electrode active material, and the negative electrode includes a negative electrode material layer containing a negative electrode active material.

### SUMMARY

The present disclosure relates to a secondary battery.

Herein, in the secondary battery, for the positive electrode active material as a constituent element thereof, to suppress a side reaction with the electrolyte solution, a first coating film attached to the surface of the positive electrode active material and a second coating film attached to the first coating film may be provided. In this case, due to the presence of these coating films, the movement of lithium ions during charge and discharge of the battery is hindered, and the internal resistance of the battery may increase. In this regard, it is required to more suitably achieve both suppression of side reaction with the electrolyte solution and ease of movement of lithium ions during charge and discharge of the battery.

The present disclosure has been devised in view of such circumstances according to an embodiment. In an embodiment, the present disclosure relates to providing a secondary battery capable of more suitably achieving both suppression of side reaction with an electrolyte solution and ease of movement of lithium ions during charge and discharge of the battery.

In an embodiment, the present disclosure provides a secondary battery including
a positive electrode active material composite containing a positive electrode active material containing an oxide containing Li and Co, and two or more coating layers at least partially covering the positive electrode active material, in which
the two or more coating layers include a first coating layer and a second coating layer from the positive electrode active material side toward the outside, one of the first coating layer and the second coating layer includes Al element, and the other of the first coating layer and the second coating layer includes at least one element selected from the group consisting of F, Mg, Mn, and Ti.

The secondary battery according to an embodiment of the present disclosure can more suitably achieve both suppression of side reaction with an electrolyte solution and ease of movement of lithium ions during charge and discharge of the battery.

### BRIEF DESCRIPTION OF THE FIGURES

FIG. 1 is a sectional view schematically illustrating a basic configuration of an electrode constituting layer.

FIG. 2 is a sectional view schematically illustrating a positive electrode active material composite of a secondary battery according to an embodiment of the present disclosure.

### DETAILED DESCRIPTION

Hereinafter, a secondary battery according to an embodiment of the present disclosure will be described in further detail including with reference to drawings. Various elements in the drawings are merely shown schematically and exemplarily for the understanding of the present disclosure, and the appearance, dimensional ratios, and the like may be different from actual ones.

The term “secondary battery” in the present specification means a battery that can be repeatedly charged and discharged. The “secondary battery” is not unduly restricted by the name of the secondary battery, which can encompass, for example, a “power storage device” and the like. The term “sectional view” used in the present specification is a state when viewed from a direction substantially perpendicular to the thickness direction based on the stacking direction of the electrode materials constituting the secondary battery. The “vertical direction” and “horizontal direction” used directly or indirectly in the present specification correspond to a vertical direction and a horizontal direction in the drawings, respectively. In a preferred aspect, it can be understood that a downward direction in a vertical direction (that is, a direction in which gravity acts) corresponds to a “downward direction”, and an opposite direction corresponds to an “upward direction”.

Various numerical ranges mentioned in the present specification are intended to include the numerical values themselves of the lower and upper limits. More specifically, when a numerical range such as 1 to 10 is taken as an example, the example can be interpreted as including the lower limit of “1” and also including the upper limit of “10”.

First, a basic configuration of the secondary battery will be described. The secondary battery has a structure in which an electrode assembly and an electrolyte are housed and enclosed inside an exterior body. The electrode assembly may include a positive electrode, a negative electrode, and a separator disposed between the positive electrode and the negative electrode. The electrode assembly may be a stacked electrode assembly or a wound (jelly roll type) electrode assembly. The stacked electrode assembly is obtained by stacking a plurality of electrode constituting layers each including a positive electrode, a negative electrode, and a separator. The wound electrode assembly is obtained by winding a plurality of electrode constituting layers each including a positive electrode, a negative electrode, and a separator. In addition, for example, the electrode assembly may have a so-called stack and folding structure, in which the positive electrode, the separator, and the negative electrode are stacked on a long film, and then folded.

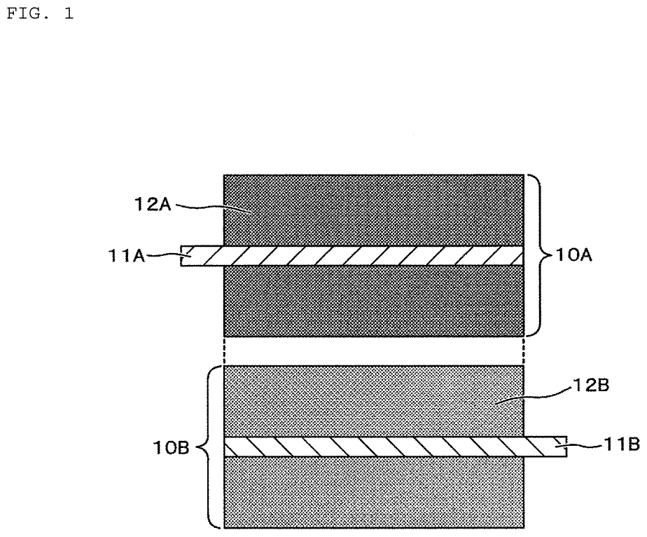

A positive electrode 10A includes at least a positive electrode current collector 11A and a positive electrode material layer 12A (see FIG. 1), and the positive electrode material layer 12A is provided on at least one surface of the positive electrode current collector 11A. At a site of the positive electrode current collector 11A where the positive electrode material layer 12A is not provided, that is, at the end of the positive electrode current collector 11A, a positive electrode-side extended tab is positioned. The positive electrode material layer 12A contains therein a positive electrode active material as an electrode active material. A negative electrode 10B includes at least a negative electrode current collector 11B and a negative electrode material layer 12B (see FIG. 1), and the negative electrode material layer 12B is provided on at least one surface of the negative electrode current collector 11B. At a site of the negative electrode current collector 11B where the negative electrode material layer 12B is not provided, that is, at the end of the negative electrode current collector 11B, a negative electrode-side extended tab is positioned. The negative electrode material layer 12B includes therein a negative electrode active material as an electrode active material.

The positive electrode active material included in the positive electrode material layer 12A and the negative electrode active material included in the negative electrode material layer 12B are substances directly involved in the transfer of electrons in the secondary battery and are main substances of the positive and negative electrodes that involve a battery reaction such as charge-discharge. More specifically, ions are brought into the electrolyte due to “the positive electrode active material included in the positive electrode material layer 12A” and “the negative electrode active material included in the negative electrode material layer 12B”, and such ions move between the positive electrode 10A and the negative electrode 10B to transfer electrons, thereby leading to charge-discharge. The positive electrode material layer 12A and the negative electrode material layer 12B are preferably layers capable of occluding and releasing, in particular, lithium ions. More specifically, a secondary battery is preferred in which lithium ions move between the positive electrode 10A and the negative electrode 10B through the electrolyte to charge and discharge the battery. When lithium ions are involved in charge-discharge, the secondary battery corresponds to a so-called “lithium ion battery”.

The positive electrode active material of the positive electrode material layer 12A includes, for example, a granular material, and a binder is preferably included in the positive electrode material layer 12A for more sufficient contact between grains and shape retention. Further, a conductive auxiliary agent may be included in the positive electrode material layer 12A to facilitate transfer of electrons that promotes the battery reaction. Similarly, the negative electrode active material of the negative electrode material layer 12B includes, for example, a granular material, a binder is preferably included in the negative electrode material layer 12B for more sufficient contact between grains and shape retention, and a conductive auxiliary agent may be included in the negative electrode material layer 12B to facilitate transfer of electrons that promotes the battery reaction. The positive electrode material layer 12A and the negative electrode material layer 12B can also be referred to as “positive electrode mixture layer” and “negative electrode mixture layer”, respectively, because multiple components are included therein.

The positive electrode active material is preferably a material that contributes to occlusion and release of lithium ions. From such a viewpoint, the positive electrode active material is preferably, for example, a lithium-containing composite oxide. More specifically, the positive electrode active material is preferably a lithium-transition metal composite oxide containing lithium and at least one transition metal selected from the group consisting of cobalt, nickel, manganese, and iron. In other words, such a lithium-transition metal composite oxide is preferably included as a positive electrode active material in the positive electrode material layer 12A of the secondary battery. For example, the positive electrode active material may be lithium cobalt oxide, lithium nickelate, lithium manganate, lithium iron phosphate, or a material obtained by replacing a part of the transition metal thereof with another metal. Such positive electrode active materials may be included singly, or in combination of two or more thereof. In the following description of the characteristic portions of the present disclosure and subsequent sections, it is assumed that the positive electrode active material included in the positive electrode material layer 12A is lithium cobalt oxide.

The binder that can be included in the positive electrode material layer 12A is not particularly limited, and examples of the binder include at least one selected from the group consisting of polyvinylidene fluoride, a vinylidene fluoride-hexafluoropropylene copolymer, a vinylidene fluoride-tetrafluoroethylene copolymer, polytetrafluoroethylene, and the like. The conductive auxiliary agent that can be included in the positive electrode material layer 12A is not particularly limited, and examples thereof include at least one selected from carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, and polyphenylene derivatives. For example, the binder of the positive electrode material layer 12A may be polyvinylidene fluoride. By way of example only, the conductive auxiliary agent of the positive electrode material layer 12A is carbon black. Further, the binder and conductive auxiliary agent of the positive electrode material layer 12A may be a combination of polyvinylidene fluoride and carbon black.

The negative electrode active material is preferably a material that contributes to occlusion and release of lithium ions. From such a viewpoint, the negative electrode active material is preferably, for example, various carbon materials, oxides, lithium alloys, or the like.

Examples of the various carbon materials for the negative electrode active material include graphite (natural graphite and artificial graphite), soft carbon, hard carbon, and diamond-like carbon. In particular, graphite is preferred in terms of high electron conductivity and excellent adhesiveness to the negative electrode current collector 11B. Examples of the oxides for the negative electrode active material include at least one selected from the group consisting of silicon oxide, tin oxide, indium oxide, zinc oxide, and lithium oxide. The lithium alloy for the negative electrode active material may be an alloy of lithium and any metal that can be alloyed with lithium, for example a binary, ternary, or higher-order alloy of lithium and a metal such as Al, Si, Pb, Sn, In, Bi, Ag, Ba, Ca, Hg, Pd, Pt, Te, Zn, or La. Such an oxide is preferably amorphous as its structural form. This is because deterioration due to nonuniformity such as crystal grain boundaries or defects is less likely to be caused. By way of example only, the negative electrode active material of the negative electrode material layer 12B may be artificial graphite.

The binder that can be included in the negative electrode material layer 12B is not particularly limited, and examples thereof include at least one selected from the group consisting of a styrene-butadiene rubber, a polyacrylic acid, a polyvinylidene fluoride, a polyimide-based resin, and a polyamideimide-based resin. For example, the binder included in the negative electrode material layer 12B may be a styrene-butadiene rubber. The conductive auxiliary agent that can be included in the negative electrode material layer 12B is not particularly limited, and examples thereof include at least one selected from: carbon black such as thermal black, furnace black, channel black, ketjen black, and acetylene black; carbon fibers such as graphite, carbon nanotubes, and vapor grown carbon fibers; metal powders such as copper, nickel, aluminum, and silver; and polyphenylene derivatives. The negative electrode material layer 12B may include therein a component derived from a thickener component (for example, a carboxymethyl cellulose) used in manufacturing the battery.

By way of example only, the negative electrode active material and binder in the negative electrode material layer 12B may be a combination of artificial graphite and styrene-butadiene rubber.

The positive electrode current collector 11A and the negative electrode current collector 11B used for the positive electrode 10A and the negative electrode 10B are members that contribute to collecting and supplying electrons generated in the active materials due to the battery reaction. Such a current collector may be a metal member in a sheet form, and may have a porous or perforated form. For example, the current collector may be a metal foil, a punching metal, a net, an expanded metal, or the like. The positive electrode current collector 11A used for the positive electrode 10A is preferably a metal foil including at least one selected from the group consisting of aluminum, stainless steel, nickel, and the like, and may be, for example, an aluminum foil. In contrast, the negative electrode current collector 11B used for the negative electrode 10B is preferably a metal foil including at least one selected from the group consisting of copper, stainless steel, and nickel, and may be, for example, a copper foil.

The separator is a member provided from the viewpoint of preventing a short circuit due to contact between the positive and negative electrodes, holding the electrolyte, and the like. In other words, the separator can be a member that allows ions to pass while preventing electronic contact between the positive electrode 10A and the negative electrode 10B. Preferably, the separator is a porous or microporous insulating member, and has a membrane form due to its small thickness. By way of example only, a microporous membrane made of a polyolefin may be used as the separator. In this respect, the microporous membrane for use as the separator may contain, for example, only polyethylene (PE) or only polypropylene (PP) as the polyolefin. Further, the separator may be a stacked body composed of a “microporous membrane made of PE” and a “microporous membrane made of PP”. The surface of the separator may be covered with an inorganic particle coating layer and/or an adhesive layer or the like. The surface of the separator may have adhesiveness.

The separator should not be particularly restricted by its name, and may be a solid electrolyte, a gel-like electrolyte, insulating inorganic particles, and the like that have a similar function. Further, from the viewpoint of further improving handling of the electrodes, the separator and the electrodes (positive electrode 10A/negative electrode 10B) are preferably bonded with each other. The separator can be bonded to the electrode by using an adhesive separator as the separator, by application and/or thermocompression bonding of an adhesive binder onto the electrode material layer (positive electrode material layer 12A/negative electrode material layer 12B), or the like. Examples of the material of the adhesive binder that provides adhesiveness to the separator or the electrode material layer include polyvinylidene fluoride, a vinylidene fluoride-hexafluoropropylene polymer, and an acrylic resin. The thickness of the adhesive layer by the adhesive binder application or the like may be 0.5 μm or more and 5 μm or less.

When the positive electrode 10A and the negative electrode 10B include a layer capable of occluding and releasing lithium ions, the electrolyte is preferably a “nonaqueous” electrolyte such as an organic electrolyte and/or an organic solvent (that is, the electrolyte is preferably a nonaqueous electrolyte). In the electrolyte, metal ions released from the electrodes (positive electrode 10A/negative electrode 10B) will be present, and the electrolyte will thus assist the movement of the metal ions in the battery reaction.

The nonaqueous electrolyte is an electrolyte containing a solvent and a solute. As a specific solvent for the nonaqueous electrolyte, a solvent containing at least a carbonate is preferred. Such a carbonate may be cyclic carbonates and/or chain carbonates. Although not particularly limited, examples of the cyclic carbonates include at least one selected from the group consisting of a propylene carbonate (PC), an ethylene carbonate (EC), a butylene carbonate (BC), and a vinylene carbonate (VC). Examples of the chain carbonates include at least one selected from the group consisting of a dimethyl carbonate (DMC), a diethyl carbonate (DEC), an ethyl methyl carbonate (EMC), and a dipropyl carbonate (DPC). By way of example only, a combination of the cyclic carbonates and the chain carbonates is used as the nonaqueous electrolyte, and for example, a mixture of ethylene carbonate and diethyl carbonate may be used. In addition, as a specific solute for the nonaqueous electrolyte, for example, an Li salt such as LiPF6 or LiBF4 is preferably used. In addition, as a specific solute for the nonaqueous electrolyte, for example, an Li salt such as LiPF6 and/or LiBF4 is preferably used.

As the positive electrode current collecting lead and the negative electrode current collecting lead, it is possible to use any current collecting lead that is used in the field of secondary batteries. Such a current collecting lead may contain a material that can achieve the movement of electrons, and contains, for example, a conductive material such as aluminum, nickel, iron, copper, and stainless steel. The positive electrode current collecting lead preferably contains aluminum, and the negative electrode current collecting lead preferably contains nickel. The forms of the positive electrode current collecting lead and negative electrode current collecting lead are not particularly limited, and may be, for example, a wire or plate shape.

Any external terminal that is used in the field of secondary batteries can be used as the external terminal. Such an external terminal may be made of a material that can achieve the movement of electrons, and is typically made of a conductive material such as aluminum, nickel, iron, copper, and stainless steel. The external terminal 5 may be electrically and directly connected to a substrate, or may be electrically and indirectly connected to the substrate with another device interposed therebetween. The present disclosure is not limited thereto, and the positive electrode current collecting lead that is connected to each of the plurality of positive electrodes may have the function of a positive electrode external terminal, whereas the negative electrode current collecting lead that is connected to each of the plurality of negative electrodes may have the function of a negative electrode external terminal.

The exterior body may have the form of a conductive hard case or a flexible case (such as a pouch). When the form of the exterior body is a flexible case (such as a pouch), each of the plurality of positive electrodes is connected to the positive electrode external terminal with the positive electrode current collecting lead interposed therebetween. The positive electrode external terminal is fixed to the exterior body with a sealing portion, and the sealing portion prevents the electrolyte from being leaked. Similarly, each of the plurality of negative electrodes is connected to the negative electrode external terminal with the negative electrode current collecting lead interposed therebetween. The negative electrode external terminal is fixed to the exterior body with a sealing portion, and the sealing portion prevents the electrolyte from being leaked. The present disclosure is not limited thereto, and the positive electrode current collecting lead that is connected to each of the plurality of positive electrodes may have the function of a positive electrode external terminal, whereas the negative electrode current collecting lead that is connected to each of the plurality of negative electrodes may have the function of a negative electrode external terminal. When the form of the exterior body is a conductive hard case, each of the plurality of positive electrodes is connected to the positive electrode external terminal with the positive electrode current collecting lead interposed therebetween. The positive electrode external terminal is fixed to the exterior body with a sealing portion, and the sealing portion prevents the electrolyte from being leaked.

The conductive hard case is composed of a main body and a lid. The main body is composed of a bottom constituting the bottom surface of the exterior body and a side surface portion. The main body and the lid are sealed after housing the electrode assembly, the electrolyte, the current collecting leads, and the external terminals. The sealing method is not particularly limited, and examples thereof include a laser irradiation method. As a material constituting the main body and the lid, it is possible to use any material that can constitute a hard case type exterior body in the field of secondary batteries. Such a material may be any material that can achieve the movement of electrons, and examples of the material can include conductive materials such as aluminum, nickel, iron, copper, and stainless steel. The dimensions of the main body and lid are determined mainly depending on the dimension of the electrode assembly, and for example, the main body and the lid preferably have such a dimension that the movement (displacement) of the electrode assembly within the exterior body is prevented when the electrode assembly is housed. Preventing the movement of the electrode assembly prevents the electrode assembly from being broken, and improves the safety of the secondary battery.

The flexible case is composed of a soft sheet. The soft sheet only needs to have such softness that the sealing portion can be bent, and is preferably a plastic sheet. The plastic sheet is a sheet that has the property of maintaining the deformation by an external force when the external force is applied and then removed, and for example, a so-called laminate film can be used. A flexible pouch formed from a laminate film can be manufactured, for example, by stacking two laminate films on one another and heat-sealing the peripheral edge thereof. As the laminate film, a film obtained by laminating a metal foil and a polymer film is common, and specifically, a three-layer film composed of an outer layer polymer film/a metal foil/an inner layer polymer film is exemplified. The outer layer polymer film is intended to prevent damage to the metal foil due to permeation and contact of moisture and the like, and polymers such as a polyamide and a polyester can be suitably used. The metal foil is intended to prevent permeation of moisture and gas, and a foil of copper, aluminum, stainless steel, or the like can be suitably used. The inner layer polymer film is intended to protect the metal foil from the electrolyte housed inside, and for melt-sealing in heat sealing, and polyolefin or acid-modified polyolefin can be suitably used.

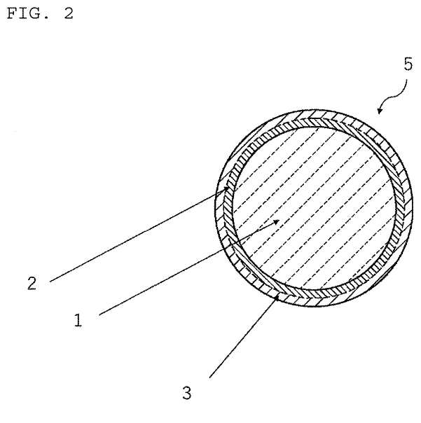

Hereinafter, characteristic parts of the present disclosure will be described according to an embodiment. Characteristic parts of the present disclosure relate to a positive electrode active material that is a constituent element of the secondary battery. The present disclosure is characterized in including a positive electrode active material composite 5 including a positive electrode active material 1 and two or more coating layers at least partially covering the positive electrode active material 1 as compared with a conventional positive electrode active material (refer to FIG. 2). FIG. 2 is a sectional view schematically illustrating a positive electrode active material composite of a secondary battery according to an embodiment of the present disclosure. This positive electrode active material composite can also be referred to as a positive electrode active material with a coating layer.

In the positive electrode active material composite 5, two or more coating layers at least partially covering the positive electrode active material 1 include the first coating layer 2 and the second coating layer 3 from the positive electrode active material 1 side toward the outside. In the present specification, the two or more coating layers may at least partially cover the surface of the positive electrode active material 1, and can preferably cover the entire surface of the positive electrode active material 1. In the present disclosure, one of the first coating layer 2 and the second coating layer 3 includes Al element, and the other of the first coating layer 2 and the second coating layer 3 includes at least one element selected from the group consisting of F, Mg, Mn, and Ti. Preferably, one of the first coating layer 2 and the second coating layer 3 is composed of Al element. Both the positive electrode active material 1 and the two or more coating layers may be a fired body.

With such a configuration, the presence of the coating layer can suppress the contact of the positive electrode active material (core) located inside with the electrolyte solution as compared with the case where none of the coating layers is present. This makes it possible to improve the voltage drop after charge storage of the battery.

In addition, although the coating layer is composed of two or more layers, selecting specific elements for the constituent elements of the respective coating layers of at least the first coating layer 2 and the second coating layer 3 makes it possible to suppress hindrance of movement of lithium ions during charge and discharge of the battery as compared with a case where the number of coating layers is one, and it is possible to secure ease of movement of lithium ions. As a result, the discharge rate characteristics can be improved as compared with the case where the number of coating layers is one. In addition, the pre-cycle resistance and the resistance increase rate of the battery can be reduced. As a result, the battery characteristics can be improved as a whole.

The term “pre-cycle resistance” as used herein refers to battery resistance in a pre-cycle stage. In addition, the resistance increase rate of the battery referred to in the present specification refers to a rate of resistance increase before and after charge and discharge. The discharge rate as used herein refers to a relative ratio of a current during discharge to a battery capacity.

In addition, as compared with a case where one of the first coating layer 2 and the second coating layer 3 is composed of Al element and the other of the first coating layer 2 and the second coating layer 3 is composed of one element selected from the group consisting of F, Mg, Mn, and Ti, the other of the first coating layer 2 and the second coating layer 3 can improve the discharge rate characteristics and reduce the pre-cycle resistance and the resistance increase rate of the battery.

When the first coating layer 2 includes elements of F, Mg, and Mn and the second coating layer 3 includes Al element, the discharge rate characteristics can be improved as compared with the case where the first coating layer 2 includes Al element and the second coating layer 3 includes elements of F, Mg, and Mn.

When the second coating layer 3 includes Ti, Mg, and Mn elements, the discharge rate characteristics can be improved, and the pre-cycle resistance and the resistance increase rate of the battery can be reduced as compared with the case where the second coating layer 3 includes F, Mg, and Mn elements. That is, when the second coating layer 3 includes Ti rather than F, it can be said that these effects are easily exhibited. At least one of the first coating layer 2 and the second coating layer 3 may have an oxide form of the above constituent elements.

In addition, in the present disclosure, the positive electrode active material 1 preferably includes trivalent Co ions (Co3+). The positive electrode active material 1 is not limited thereto, and can include divalent or tetravalent Co ions. The valence of Co ions included in the positive electrode active material 1 is controlled to be trivalent, which may cause charge bias to occur on the surface of the positive electrode active material 1. Due to the occurrence of such charge bias, two or more coating layers (may also be referred to as coating composite layers) can suitably adhere to the surface of the positive electrode active material. As a result, the electron conductivity can be improved as a whole, and the reaction resistance of the battery during charge and discharge of the battery can be reduced although the coating layer has two or more layers.

Further, when the positive electrode active material 1 includes trivalent Co ions (Co3+), the positive electrode active material 1 preferably includes both Co3+ in a low-spin (LS) state and Co3+ in an intermediate spin (IS) state. In this case, the ratio of Co3+ in the intermediate spin (IS) state to Co3+ in the low-spin (LS) state is preferably 5% or more from the viewpoint of suitably generating charge bias on the surface of the positive electrode active material 1, and may be 1% or less from the viewpoint of stability of the crystal structure.

Spin determines the magnetic properties of electrons, and is a matter in the 3d electron orbit. In the 3d electron orbital, the electrons of Co may have two types of orbitals, that is, a t2g orbit extending in a direction avoiding oxygen and an eg orbit extending in a direction in which oxygen exists. The t2g orbit is in the direction avoiding oxygen, and thus is energetically stable compared to the eg orbit. The t2g orbit has orbits in three directions, and a total of two electrons including an upward spin and a downward spin can enter each orbit. In the t2g orbit, six electrons as a whole can enter. Meanwhile, the eg orbit has orbits in two directions, and a total of two electrons including an upward spin and a downward spin can enter each orbit. In the eg orbit, four electrons can enter as a whole.

Assuming such a configuration, when the six 3d electrons of the trivalent Co ion (Co3+) enter the stable t2g orbit, exactly six electrons enter the t2g orbit, three upward electrons and three downward electrons cancel each other, and the total of spins becomes S=0. In the present specification, this state may be referred to as a low-spin state.

Meanwhile, in Co atoms, it is also possible that the alignment of spin directions is selected instead of stable orbitals. In this case, the upward spin enters the t2g orbit and the eg orbit from the viewpoint of aligning the directions of the spins. In this state, the spins of the five electrons can be arranged upward. Meanwhile, the remaining one electron can enter the energetically stable t2g orbit with a downward spin. As a result, a high spin state of S=2 may be obtained.

The intermediate spin (IS) state as used herein refers to a state between the low spin state and the high spin state. Specifically, among the spins of the four electrons, the spins of the three electrons may enter the t2g orbit upward, and the spin of one electron may enter the eg orbit upward. Meanwhile, the remaining two electrons can enter the t2g orbit in which the energy is stabilized with a downward spin. As a result, an intermediate spin state of S=1 may be obtained.

When Co3+ in the intermediate spin state is included in the positive electrode active material, charge bias can be more easily generated. As a result, lithium ions can be easily diffused from the positive electrode active material 1 located inside to the coated composite layer side located outside. As a result, it is possible to further improve the discharge rate characteristics and reduce the pre-cycle resistance and the resistance increase rate of the battery.

In addition, the thickness of the first coating layer 2 may be 0.1 μm or more from the viewpoint of alleviating stress due to expansion-contraction of the positive electrode active material in association with charge and discharge. In addition, the thickness of the first coating layer 2 may be 2 μm or less from the viewpoint of not hindering the movement of lithium ions in association with charge and discharge. In addition, from the viewpoint of suppressing contact between the positive electrode active material 1 and the first coating layer, and the electrolyte, the thickness of the second coating layer 3 may be 0.1 μm or more. For example, the thickness of the second coating layer 3 may be smaller than the average particle size of the particles of the positive electrode active material 1, and may be, for example, 100 nm or less. In this case, the particle size of the positive electrode active material itself may be 3 μm or more and 30 μm or less in terms of D50 (corresponding to a median diameter).

Hereinafter, a method for producing a secondary battery according to an embodiment of the present disclosure including the step of producing the positive electrode active material composite 5 (positive electrode active material+two or more coating layers) will be schematically described.

First, a cobalt-containing material is mixed with a lithium carbonate solution such that the ratio of Li to Co (Li/Co) is 1.05. The mixed solution is subjected to primary firing in an air atmosphere. Specifically, pre-firing is performed, for example, at a temperature of 500° C. or more and 700° C. or less for a predetermined time (for example, 4 hours or more and 6 hours or less), and then main firing is performed, for example, at a temperature of 800° C. or more and 900° C. or less for a predetermined time (for example, 12 hours or more and 20 hours or less). Thereby, the positive electrode active material 1 of the composite oxide can be obtained.

Thereafter, the obtained positive electrode active material 1 is immersed in one of an Al-containing solution and a solution containing at least one element selected from the group consisting of F, Mg, Mn, and Ti, and then dried at room temperature (approximately 25° C.). Thereby, a precursor of the first coating layer is formed.

After the precursor of the first coating layer is formed, the precursor is immersed in the other solution of the Al-containing solution and the solution containing at least one element selected from the group consisting of F, Mg, Mn, and Ti, and then dried at room temperature (approximately 25° C.). Thereby, a precursor of the second coating layer is formed.

After the precursor of the second coating layer is formed, secondary firing is performed in a state where the precursors of the two coating layers are attached to the positive electrode active material. The secondary firing is performed at a firing temperature of 600° C. or more and 1100° C. or less and at a heating rate (° C./min) of 80° C. or more and 120° C. or less per minute. The retention time may be 5 minutes or more and 250 minutes or less. As described above, a positive electrode active material composite can be obtained.

After the positive electrode active material composite is obtained, element mapping is performed on the positive electrode active material composite using an EDX analyzer (energy dispersive X-ray fluorescence analyzer). Specifically, irradiating the positive electrode active material composite with X-rays and analyzing the energy (or wavelength) and intensity of the generated fluorescent X-rays using an EDX analyzer make it possible to analyze the types and contents of elements constituting each coating layer.

After the formation of the positive electrode active material composite, the positive electrode active material composite, the binder described above, and the conductive auxiliary agent are weighed in a predetermined ratio and mixed with a solvent to form a positive electrode material layer slurry. Similarly, the negative electrode active material described above, the binder, and the conductive auxiliary agent are weighed in a predetermined ratio and mixed with a solvent to form a negative electrode material layer slurry. Thereafter, the positive electrode material layer slurry is applied onto the positive electrode current collector to form a positive electrode precursor. In addition, the negative electrode material layer slurry is applied onto the negative electrode current collector to form a negative electrode precursor. Thereafter, each electrode precursor is dried and pressed to finally form a predetermined positive electrode and a predetermined negative electrode.

Thereafter, the formed positive electrode and negative electrode are alternately stacked with the separator interposed therebetween to form an electrode assembly, the formed electrode assembly is housed in an exterior body, and the above-described electrolyte solution is sealed, whereby the secondary battery according to one embodiment of the present disclosure can be finally produced.

### EXAMPLES

Examples of the present disclosure will be described below according to an embodiment.

### Example 1

### [Step of Fabricating Positive Electrode Active Material]

Cobalt (II) sulfate heptahydrate (FUJIFILM Wako Pure Chemical Corporation) was dissolved in distilled water so as to have a molar concentration of 1.5 mol/L to obtain a cobalt sulfate aqueous solution. Ammonium sulfate (FUJIFILM Wako Pure Chemical Corporation) was dissolved in distilled water so as to have a molar concentration of 1.5 mol/L to obtain an ammonium sulfate aqueous solution.

Then, distilled water was put into a 2 L reaction tank and heated to 50° C. with a heater, and the sulfate aqueous solution and the ammonium sulfate aqueous solution were added while the solution in the reaction tank was stirred with a paddle type stirring blade. The rate of the sulfate aqueous solution added was 5.0 g/min. The ammonium sulfate aqueous solution was added such that the pH was maintained at 8.0. Each solution was added over 24 hours to precipitate a coprecipitate.

The obtained coprecipitate was washed by repeating pressure filtration and dispersion in distilled water to remove impurity ions. The washing was finished when the electrical conductivity of the filtrate was less than 20 mS/m. The washed coprecipitate was heated at 100° C. for 10 hours and dried.

Then, the resulting coprecipitate and lithium carbonate were mixed such that the molar ratio of Li to Co (Li/Co) was 1.05. This mixed solution was subjected to primary firing in an air atmosphere. Specifically, pre-firing was performed at 600° C. for 5 hours, and then main firing was performed at 845° C. for 16 hours. As a result, a positive electrode active material composed of a composite oxide containing Co and Li was obtained. The primary firing treatment was performed using a firing apparatus.

### [Step of Coating Positive Electrode Active Material]

Thereafter, the obtained positive electrode active material was immersed in an Al(OH)3 solution (concentration: 10%) for 1 hour, and then dried at room temperature (approximately 25° C.). Thereby, a precursor of the first coating layer was formed.

After forming the precursor of the first coating layer, the precursor was immersed in an MgF2 solution (concentration: 10%) for 1 hour, and then dried at room temperature (approximately 25° C.). Thereby, a precursor of the second coating layer was formed.

After the precursor of the second coating layer was formed, secondary firing was performed in a state where the precursors of the two coating layers were attached to the positive electrode active material. The secondary firing was performed at a firing temperature of 1050° C. at a heating rate (° C./min) of 100° C. per minute. The retention time was 0.5 hours. The secondary firing treatment was performed using a firing apparatus. As described above, a positive electrode active material composite was able to be obtained.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of Al element. In addition, it has been found that the second coating layer adhering to the first coating layer was composed of the F element.

### [Step of Fabricating Cell]

After the formation of the positive electrode active material composite, the positive electrode active material composite, a binder (polyvinylidene fluoride), and a conductive auxiliary agent (carbon black) were weighed in a predetermined ratio, and mixed with an NMP (N-methyl-2-pyrrolidone) solvent to form a positive electrode material layer slurry. Similarly, a negative electrode active material (graphite), a binder (polyvinylidene fluoride), and a conductive auxiliary agent (carbon black) were weighed in a predetermined ratio, and mixed with an NMP solvent to form a negative electrode material layer slurry. Thereafter, the positive electrode material layer slurry was applied onto the positive electrode current collector (Al metal foil) using a coating machine to form a positive electrode precursor. Specifically, the coating was performed such that the area density of the positive electrode precursor was 18 mg/cm2. Thereafter, the positive electrode precursor was dried at a predetermined temperature and pressed to finally form a positive electrode.

Thereafter, a coin cell having a diameter of 20 mm and a thickness of 1.6 mm was fabricated using: an electrode for evaluation obtained by punching the pressed electrode sheet to a diameter of 16.5 mm; metal lithium as a counter electrode; an organic electrolyte solution obtained by dissolving 1 mol/L lithium hexafluorophosphate (LiPF6) in a solvent in which EC:EMC was used as an electrolyte solution at a weight ratio of 1:3; and a polyethylene porous film as a separator. As described above, the secondary battery of Example 1 was fabricated.

### [Evaluation of Battery Characteristics]

Thereafter, the obtained coin cell was initially charged and discharged at a current value corresponding to 0.1 C and a voltage range of 4.55 to 3.0 V in a thermostatic chamber at 25° C. Subsequently, the battery was charged at 0.1 C up to a voltage range of 4.55 V, and then discharged at 0.1 C. Charge and discharge at 1 C and 3 C were also repeated. Thereafter, a charge-discharge cycle of 1 C-1 C was repeated 100 times. A low rate cycle of 0.05 C was performed before and after the cycle test and at any cycle time point. The degradation rate was calculated based on the result of 0.05 C cycles.

In addition, with respect to the electronic state of Co, the magnetic susceptibility was measured by a magnetic susceptibility measurement device, and as a result, it was found that Co was in an intermediate spin state of S=1. In such measurement, a positive electrode active material as a powder sample, which is a positive electrode active material, was enclosed in a gelatin capsule, which is a diamagnetic material, and then a sample holder placed in the capsule was attached to a sample vertical moving rod. The inside of the sample space was under a helium gas atmosphere of less than atmospheric pressure. When the positive electrode active material was put into the superconducting wire detection coil under a constant magnetic field environment generated by the superconducting magnet, an output voltage depending on the sample position in the detection coil was obtained. Then, the magnetic moment value was calculated by comparing with the sample position dependency of the output voltage during measurement of the magnetic moment standard sample, and then the magnetic susceptibility was measured from the sum of the magnetic moments.

The number n of atoms having an unpaired electron in the sample can be determined by the following measurement formula.

n=3kBCCurie(μ0μeff2H)−1
where kB and μ0 are the Boltzmann constant and the vacuum permeability, respectively. CCurie is the gradient of the magnetic moment m and the temperature T measured by the SQUID.

Effective magnetic moment meff=gJ[J(J+1)]1/2 mB
gJ is the Lande g-factor, and J is a synthetic angular momentum. Both can be theoretically obtained from the electron arrangement based on the Pauli exclusion principle and the Hund's rule.

### [Measurement Results]

In Example 1, as shown in Table 1 below, after charge and discharge, the discharge rate was 25%, the pre-cycle resistance was 10 ohms, and the resistance increase rate of the battery was 17%. In the positive electrode active material, it has been found that 5% (molar ratio) of Co in the intermediate spin state can be secured by adjusting the molar ratio of Li to Co (Li/Co) to 1.05.

Hereinafter, each example and the like will be described focusing on differences from Example 1. Description of similar steps is omitted to avoid duplication of description.

### Example 2

In Example 2, [Step of fabricating positive electrode active material] was performed in the same manner as in Example 1. Thereafter, in the [Step of coating positive electrode active material], as in Example 1, the obtained positive electrode active material was immersed in an Al(OH)3 solution (concentration: 10%) for 1 hour, and then dried at room temperature (approximately 25° C.). Thereby, a precursor of the first coating layer was formed.

After forming the precursor of the first coating layer, the precursor was immersed in an Mg(OH)2 solution (concentration: 10%) for 1 hour, and then dried at room temperature (approximately 25° C.). Thereby, a precursor of the second coating layer was formed.

After the precursor of the second coating layer was formed, secondary firing was performed in a state where the precursors of the two coating layers were attached to the positive electrode active material. The secondary firing was performed at a firing temperature of 1050° C. at a heating rate (° C./min) of 100° C. per minute. The retention time was 0.5 hours. The secondary firing treatment was performed using a firing apparatus. As described above, a positive electrode active material composite was obtained.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of Al element. In addition, it has been found that the second coating layer adhering to the first coating layer was composed of the Mg element.

The same [Step of fabricating cell] and [Evaluation of battery characteristics] as in Example 1 were performed. In [Measurement results] obtained after that, in Example 2, as shown in Table 1 below, after charge and discharge, the discharge rate was 27%, the pre-cycle resistance was 10 ohms, and the resistance increase rate of the battery was 18%. In the positive electrode active material, it has been found that 5% (molar ratio) of Co in the intermediate spin state can be secured by adjusting the molar ratio of Li to Co (Li/Co) to 1.05.

### Example 3

In Example 3, [Step of fabricating positive electrode active material] was performed in the same manner as in Example 1. Thereafter, in the [Step of coating positive electrode active material], as in Example 1, the obtained positive electrode active material was immersed in an Al(OH)3 solution (concentration: 10%) for 1 hour, and then dried at room temperature (approximately 25° C.). Thereby, a precursor of the first coating layer was formed.

After forming the precursor of the first coating layer, the precursor was immersed in an Mn(CO)3 solution (concentration: 10%) for 1 hour, and then dried at room temperature (approximately 25° C.). Thereby, a precursor of the second coating layer was formed.

After the precursor of the second coating layer was formed, secondary firing was performed in a state where the precursors of the two coating layers were attached to the positive electrode active material. The secondary firing was performed at a firing temperature of 1050° C. at a heating rate (° C./min) of 100° C. per minute. The retention time was 0.5 hours. The secondary firing treatment was performed using a firing apparatus. As described above, a positive electrode active material composite was obtained.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of Al element. In addition, it has been found that the second coating layer adhering to the first coating layer is composed of the Mn element.

The same [Step of fabricating cell] and [Evaluation of battery characteristics] as in Example 1 were performed. In [Measurement results] obtained after that, in Example 3, as shown in Table 1 below, after charge and discharge, the discharge rate was 25%, the pre-cycle resistance was 10 ohms, and the resistance increase rate of the battery was 17%. In the positive electrode active material, it has been found that 5% (molar ratio) of Co in the intermediate spin state can be secured by adjusting the molar ratio of Li to Co (Li/Co) to 1.05.

### Example 4

In Example 4, as compared with Example 1, the obtained coprecipitate and lithium carbonate were mixed in the [Step of fabricating positive electrode active material] such that the molar ratio of Li to Co (Li/Co) was 1.00. This mixed solution was subjected to primary firing in an air atmosphere.

Thereafter, in the [Step of coating positive electrode active material], as in Example 1, the obtained positive electrode active material was immersed in an Al(OH)3 solution (concentration: 10%) for 1 hour, and then dried at room temperature (approximately 25° C.). Thereby, a precursor of the first coating layer was formed.

After the formation of the precursor of the first coating layer, the precursor was immersed for 1 hour in a solution (concentration: 10%) obtained by mixing MgF2 and Mn(CO)3 at a weight ratio of 1:1, and then dried at room temperature (approximately 25° C.). Thereby, a precursor of the second coating layer was formed.

After the precursor of the second coating layer was formed, secondary firing was performed in a state where the precursors of the two coating layers were attached to the positive electrode active material. The secondary firing was performed at a firing temperature of 1050° C. at a heating rate (° C./min) of 100° C. per minute. The retention time was 0.5 hours. The secondary firing treatment was performed using a firing apparatus. As described above, a positive electrode active material composite was obtained.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of Al element. In addition, it has been found that the second coating layer adhering to the first coating layer is composed of the F, Mg, and Mn elements.

The same [Step of fabricating cell] and [Evaluation of battery characteristics] as in Example 1 were performed. In [Measurement results] obtained after that, in Example 4, as shown in Table 1 below, after charge and discharge, the discharge rate was 29%, the pre-cycle resistance was 15 ohms, and the resistance increase rate of the battery was 23%. In the positive electrode active material, it has been found that Co in the intermediate spin state was 0% (molar ratio) by adjusting the molar ratio of Li to Co (Li/Co) to 1.00.

### Example 5

In Example 5, [Step of fabricating positive electrode active material] was performed in the same manner as in Example 1. Thereafter, in the [Step of coating positive electrode active material], the obtained positive electrode active material was immersed in a solution (concentration: 10%) obtained by mixing MgF2 and Mn(CO)3 at a weight ratio of 1:1 for 1 hour, and then dried at room temperature (approximately 25° C.). Thereby, a precursor of the first coating layer was formed.

After forming the precursor of the first coating layer, the precursor was immersed in an Al(OH)3 solution (concentration: 10%) for 1 hour, and then dried at room temperature (approximately 25° C.). Thereby, a precursor of the second coating layer was formed.

After the precursor of the second coating layer was formed, secondary firing was performed in a state where the precursors of the two coating layers were attached to the positive electrode active material. The secondary firing was performed at a firing temperature of 1050° C. at a heating rate (° C./min) of 100° C. per minute. The retention time was 0.5 hours. The secondary firing treatment was performed using a firing apparatus. As described above, a positive electrode active material composite was obtained.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of the F, Mg, and Mn elements. In addition, it has been found that the second coating layer adhering to the first coating layer was composed of the Al element.

The same [Step of fabricating cell] and [Evaluation of battery characteristics] as in Example 1 were performed. In [Measurement results] obtained after that, in Example 5, as shown in Table 1 below, after charge and discharge, the discharge rate was 32%, the pre-cycle resistance was 9 ohms, and the resistance increase rate of the battery was 15%. In the positive electrode active material, it has been found that 5% (molar ratio) of Co in the intermediate spin state can be secured by adjusting the molar ratio of Li to Co (Li/Co) to 1.05.

### Example 6

In Example 4, as compared with Example 1, the obtained coprecipitate and lithium carbonate were mixed in the [Step of fabricating positive electrode active material] such that the molar ratio of Li to Co (Li/Co) was 1.00. This mixed solution was subjected to primary firing in an air atmosphere.

Thereafter, in the [Step of coating positive electrode active material], as in Example 1, the obtained positive electrode active material was immersed in an Al(OH)3 solution (concentration: 10%) for 1 hour, and then dried at room temperature (approximately 25° C.). Thereby, a precursor of the first coating layer was formed.

After the formation of the precursor of the first coating layer, the precursor was immersed for 1 hour in a solution (concentration: 10%) obtained by mixing TiO2, Mg(OH)2, and Mn(CO)3 at a weight ratio of 1:1:1, and then dried at room temperature (approximately 25° C.). Thereby, a precursor of the second coating layer was formed.

After the precursor of the second coating layer was formed, secondary firing was performed in a state where the precursors of the two coating layers were attached to the positive electrode active material. The secondary firing was performed at a firing temperature of 1050° C. at a heating rate (° C./min) of 100° C. per minute. The retention time was 4 hours. The secondary firing treatment was performed using a firing apparatus. As described above, a positive electrode active material composite was obtained.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of Al element. In addition, it has been found that the second coating layer adhering to the first coating layer was composed of the Ti, Mg, and Mn elements.

The same [Step of fabricating cell] and [Evaluation of battery characteristics] as in Example 1 were performed. In [Measurement results] obtained after that, in Example 6, as shown in Table 1 below, after charge and discharge, the discharge rate was 29%, the pre-cycle resistance was 15 ohms, and the resistance increase rate of the battery was 20%. In the positive electrode active material, it has been found that Co in the intermediate spin state was 0% (molar ratio) by adjusting the molar ratio of Li to Co (Li/Co) to 1.00.

### Example 7

In Example 7, as compared with Example 4, the obtained coprecipitate and lithium carbonate were mixed in the [Step of fabricating positive electrode active material] such that the molar ratio of Li to Co (Li/Co) was 1.05. This mixed solution was subjected to primary firing in an air atmosphere.

Thereafter, in the [Step of coating positive electrode active material], as in Example 1, the obtained positive electrode active material was immersed in an Al(OH)3 solution (concentration: 10%) for 1 hour, and then dried at room temperature (approximately 25° C.). Thereby, a precursor of the first coating layer was formed.

After the formation of the precursor of the first coating layer, the precursor was immersed for 1 hour in a solution (concentration: 10%) obtained by mixing MgF2 and Mn(CO)3 at a weight ratio of 1:1, and then dried at room temperature (approximately 25° C.). Thereby, a precursor of the second coating layer was formed.

After the precursor of the second coating layer was formed, secondary firing was performed in a state where the precursors of the two coating layers were attached to the positive electrode active material. The secondary firing was performed at a firing temperature of 1050° C. at a heating rate (° C./min) of 100° C. per minute. The retention time was 0.5 hours. The secondary firing treatment was performed using a firing apparatus. As described above, a positive electrode active material composite was obtained.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, similarly to Example 4, it has been found that the first coating layer adhering to the surface of the positive electrode active material was composed of Al element. In addition, it has been found that the second coating layer adhering to the first coating layer is composed of the F, Mg, and Mn elements.

The same [Step of fabricating cell] and [Evaluation of battery characteristics] as in Example 1 were performed. In [Measurement results] obtained after that, in Example 7, as shown in Table 1 below, after charge and discharge, the discharge rate was 36%, the pre-cycle resistance was 9 ohms, and the resistance increase rate of the battery was 15%. In the positive electrode active material, it has been found that 5% (molar ratio) of Co in the intermediate spin state can be secured by adjusting the molar ratio of Li to Co (Li/Co) to 1.05.

### Example 8

In Example 8, as compared with Example 6, the obtained coprecipitate and lithium carbonate were mixed in the [Step of fabricating positive electrode active material] such that the molar ratio of Li to Co (Li/Co) was 1.05. This mixed solution was subjected to primary firing in an air atmosphere.

Thereafter, in the [Step of coating positive electrode active material], as in Example 1, the obtained positive electrode active material was immersed in an Al(OH)3 solution (concentration: 10%) for 1 hour, and then dried at room temperature (approximately 25° C.). Thereby, a precursor of the first coating layer was formed.

After the formation of the precursor of the first coating layer, the precursor was immersed for 1 hour in a solution (concentration: 10%) obtained by mixing TiO2, Mg(OH)2, and Mn(CO)3 at a weight ratio of 1:1:1, and then dried at room temperature (approximately 25° C.). Thereby, a precursor of the second coating layer was formed.

After the precursor of the second coating layer was formed, secondary firing was performed in a state where the precursors of the two coating layers were attached to the positive electrode active material. The secondary firing was performed at a firing temperature of 850° C. at a heating rate (° C./min) of 100° C. per minute. The retention time was 240 minutes. The secondary firing treatment was performed using a firing apparatus. As described above, a positive electrode active material composite was obtained.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of Al element. In addition, it has been found that the second coating layer adhering to the first coating layer was composed of the Ti, Mg, and Mn elements.

The same [Step of fabricating cell] and [Evaluation of battery characteristics] as in Example 1 were performed. In [Measurement results] obtained after that, in Example 8, as shown in Table 1 below, after charge and discharge, the discharge rate was 38%, the pre-cycle resistance was 8 ohms, and the resistance increase rate of the battery was 13%. In the positive electrode active material, it has been found that 5% (molar ratio) of Co in the intermediate spin state can be secured by adjusting the molar ratio of Li to Co (Li/Co) to 1.05.

### Example 9

In Example 9, as compared with Example 1, the obtained coprecipitate and lithium carbonate were mixed in the [Step of fabricating positive electrode active material] such that the molar ratio of Li to Co (Li/Co) was 1.00. This mixed solution was subjected to primary firing in an air atmosphere. Thereafter, the [Step of coating positive electrode active material] was performed in the same manner as in Example 1.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of Al element. In addition, it has been found that the second coating layer adhering to the first coating layer was composed of the F element.

The same [Step of fabricating cell] and [Evaluation of battery characteristics] as in Example 1 were performed. In [Measurement results] obtained after that, in Example 9, as shown in Table 1 below, after charge and discharge, the discharge rate was 24%, the pre-cycle resistance was 12 ohms, and the resistance increase rate of the battery was 18%. In the positive electrode active material, it has been found that Co in the intermediate spin state was 0% (molar ratio) by adjusting the molar ratio of Li to Co (Li/Co) to 1.00.

### Example 10

In Example 10, as compared with Example 2, the obtained coprecipitate and lithium carbonate were mixed in the [Step of fabricating positive electrode active material] such that the molar ratio of Li to Co (Li/Co) was 1.00. This mixed solution was subjected to primary firing in an air atmosphere. Thereafter, the [Step of coating positive electrode active material] was performed in the same manner as in Example 2.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of Al element. In addition, it has been found that the second coating layer adhering to the first coating layer was composed of the Mg element.

The same [Step of fabricating cell] and [Evaluation of battery characteristics] as in Example 1 were performed. In [Measurement results] obtained after that, in Example 10, as shown in Table 1 below, after charge and discharge, the discharge rate was 25%, the pre-cycle resistance was 11 ohms, and the resistance increase rate of the battery was 18%. In the positive electrode active material, it has been found that Co in the intermediate spin state was 0% (molar ratio) by adjusting the molar ratio of Li to Co (Li/Co) to 1.00.

### Example 11

In Example 11, as compared with Example 3, the obtained coprecipitate and lithium carbonate were mixed in the [Step of fabricating positive electrode active material] such that the molar ratio of Li to Co (Li/Co) was 1.00. This mixed solution was subjected to primary firing in an air atmosphere. Thereafter, the [Step of coating positive electrode active material] was performed in the same manner as in Example 3.

### [Elemental Analysis Step of Coating Layer]

Thereafter, elemental analysis of the two coating layers located on the surface of the positive electrode active material was performed using an EDX analyzer (energy dispersive X-ray fluorescence analyzer) (FE-TEM/EDX (JEOL JEM-F200/Noran system 7). As a result, it has been found that the first coating layer adhering to the surface of the positive electrode active material was composed of Al element. In addition, it has been found that the second coating layer adhering to the first coating layer is composed of the Mn element.

The same [Step of fabricating cell] and [Evaluation of battery characteristics] as in Example 1 were performed. In [Measurement results] obtained after that, in Example 11, as shown in Table 1 below, after charge and discharge, the discharge rate was 24%, the pre-cycle resistance was 11 ohms, and the resistance increase rate of the battery was 19%. In the positive electrode active material, it has been found that Co in the intermediate spin state was 0% (molar ratio) by adjusting the molar ratio of Li to Co (Li/Co) to 1.00.

### Comparative Example 1

In Comparative Example 1, as compared with Example 1, the obtained coprecipitate and lithium carbonate were mixed in the [Step of fabricating positive electrode active material] such that the molar ratio of Li to Co (Li/Co) was 1.00. This mixed solution was subjected to primary firing in an air atmosphere.

Thereafter, in the [Step of coating positive electrode active material], as compared with Example 1, the obtained positive electrode active material was immersed in an Al(OH)3 solution (concentration: 10%) for 1 hour, and then dried at room temperature (approximately 25° C.). Thereby, a precursor of the first coating layer was formed. However, in Comparative Example 1, the formation of the precursor of the second coating layer in the above Example was not performed.

After only the precursor of the first coating layer was formed, secondary firing was performed in a state where the precursor of the one coating layer was attached to the positive electrode active material. The secondary firing was performed at a firing temperature of 1050° C. at a heating rate (° C./min) of 100° C. per minute. The retention time was 1 hour. The secondary firing treatment was performed using a firing apparatus. As described above, a positive electrode active material composite was obtained.

### [Elemental Analysis Step of Coating Layer]

Thereafter, elemental analysis of the one coating layer located on the surface of the positive electrode active material was performed using an EDX analyzer (energy dispersive X-ray fluorescence analyzer) (FE-TEM/EDX (JEM-F200/Noran system 7, manufactured by JEOL Ltd.)). As a result, it has been found that the first coating layer adhering to the surface of the positive electrode active material was composed of Al element. No second coating layer was found.

The same [Step of fabricating cell] and [Evaluation of battery characteristics] as in Example 1 were performed. In [Measurement results] obtained after that, in Comparative Example 1, as shown in Table 1 below, after charge and discharge, the discharge rate was 20%, the pre-cycle resistance was 45 ohms, and the resistance increase rate of the battery was 33%. In the positive electrode active material, Co in the intermediate spin state was 0% (molar ratio) by adjusting the molar ratio of Li to Co (Li/Co) to 1.00.

[Table 1] Configuration and the like of coating layers and measurement results of Examples 1 to 11 and Comparative

Example 1

| | Number | Coating | Coating | Presence or | | | |
|---|---|---|---|---|---|---|---|
| | of | element | element | absence of | | Pre-cycle | Resistance |
| | coating | of first | of second | intermediate | Discharge | resistance | increase |
| | layers | layer | layer | spin | rate | (ohm) | (%) |
| Example 1 | Two | Al | F | Presence | 25% | 10 | 17 |
| | layers | | | | | | |
| Example 2 | Two | Al | Mg | Presence | 27% | 10 | 18 |
| | layers | | | | | | |
| Example 3 | Two | Al | Mn | Presence | 25% | 10 | 17 |
| | layers | | | | | | |
| Example 4 | Two | Al | F, Mg, | Absence | 29% | 15 | 23 |
| | layers | | Mn | | | | |
| Example 5 | Two | F, Mg, | Al | Presence | 32% | 9 | 15 |
| | layers | Mn | | | | | |
| Example 6 | Two | Al | Ti, Mg, | Absence | 29% | 15 | 20 |
| | layers | | Mn | | | | |
| Example 7 | Two | Al | F, Mg, | Presence | 36% | 9 | 15 |
| | layers | | Mn | | | | |
| Example 8 | Two | Al | Ti, Mg, | Presence | 38% | 8 | 13 |
| | layers | | Mn | | | | |
| Example 9 | Two | Al | F | Absence | 24% | 12 | 18 |
| | layers | | | | | | |
| Example 10 | Two | Al | Mg | Absence | 25% | 11 | 18 |
| | layers | | | | | | |
| Example 11 | Two | Al | Mn | Absence | 24% | 11 | 19 |
| | layers | | | | | | |
| Comparative | One | Al | Absence | Absence | 20% | 45 | 33 |
| Example 1 | layer | | | | | | |

(*) Coating layers with a pre-cycle resistance of 30 ohms or more and a resistance increase rate of 25% or more were treated as Comparative Examples.

### Example 1

From the measurement results of Examples 1 to 11 and Comparative Example 1, the following has been found.
When one of the first coating layer and the second coating layer is composed of Al element and the other of the first coating layer and the second coating layer is composed of one element of F, Mg, or Mn (refer to Examples 1 to 3, Examples 9 to 11), it has been found that the discharge rate characteristics can be improved, and the pre-cycle resistance and the resistance increase rate of the battery can be reduced as compared with Comparative Example 1.
When each of Examples 9 to 11 is compared with Examples 1 to 3, it has been found that Co in the intermediate spin state was 5% (molar ratio), thereby allowing the discharge rate characteristics to be improved, and the pre-cycle resistance and the resistance increase rate of the battery to be reduced.
When Examples 4 and 6 are compared with Examples 9 to 11, it has been found that the second coating layer was composed of three types of elements (F, Mg, Mn or Ti, Mg, Mn), thereby allowing the discharge rate characteristics to be improved, and the pre-cycle resistance and the resistance increase rate of the battery to be reduced.
When Example 5 is compared with Example 7, it has been found that the discharge rate characteristics were improved when the first coating layer was composed of Al element and the second coating layer was composed of three elements (F, Mg, Mn) as compared with the case where the first coating layer was composed of three elements (F, Mg, Mn) and the second coating layer was composed of Al element.
When Examples 7 and 8 are compared with Examples 4 and 6, it has been found that the second coating layer was composed of three types of elements (F, Mg, Mn or Ti, Mg, Mn) and Co in the intermediate spin state was 5% (molar ratio), thereby allowing the discharge rate characteristics to be further improved, and the pre-cycle resistance and the resistance increase rate of the battery to be further reduced.
When Example 7 is compared with Example 8, it has been found that the second coating layer includes Ti, Mg, and Mn elements, thereby allowing the discharge rate characteristics to be improved, and the pre-cycle resistance and the resistance increase rate of the battery to be further reduced as compared with the case where the second coating layer includes F, Mg, and Mn elements.
In Example 8, it has been found that the second coating layer was composed of Ti, Mg, and Mn elements, and Co in the intermediate spin state was 5% (molar ratio), and this case most effectively allows the discharge rate characteristics to be improved, and the pre-cycle resistance and the resistance increase rate of the battery to be reduced as compared with other Examples.

The present disclosure can include the following aspects according to an embodiment.

<1>

A secondary battery including
a positive electrode active material composite containing a positive electrode active material containing an oxide containing Li and Co, and two or more coating layers at least partially covering the positive electrode active material, in which
the two or more coating layers include a first coating layer and a second coating layer from the positive electrode active material side toward the outside, one of the first coating layer and the second coating layer includes Al element, and the other of the first coating layer and the second coating layer includes at least one element selected from the group consisting of F, Mg, Mn, and Ti.

<2>

The secondary battery according to <1>, in which one of the first coating layer and the second coating layer is composed of Al element.

<3>

The secondary battery according to <1> or <2>, in which the positive electrode active material and the two or more coating layers are a fired body.

<4>

The secondary battery according to any one of <1> to <3>, in which the positive electrode active material includes trivalent Co ions (Co3+).

<5>

The secondary battery according to <4>, in which the positive electrode active material includes Co3+ in an intermediate spin (IS) state.

<6>

The secondary battery according to <5>, in which the positive electrode active material further includes Co3+ in a low spin (LS) state, and a ratio of Co3+ in the intermediate spin (IS) state to Co3+ in the low spin (LS) state is 5% or more.

<7>

The secondary battery according to any one of <1> to <4>, in which the other of the first coating layer and the second coating layer includes F, Mg, and Mn elements.

<8>

The secondary battery according to <7>, in which the first coating layer includes F, Mg, and Mn elements, and the second coating layer includes Al element.

<9>

The secondary battery according to any one of <1> to <6>, in which the second coating layer includes Ti, Mg, and Mn elements.

<10>

The secondary battery according to any one of <1> to <9>, in which at least one of the first coating layer and the second coating layer has an oxide form of a constituent element.

<11>

The secondary battery according to any one of <1> to <10>, further including an electrolyte solution.

The secondary battery according to an embodiment of the present disclosure can be used in various fields where power storage is assumed. By way of example only, the secondary battery, in particular, nonaqueous electrolyte secondary battery according to an embodiment of the present disclosure can be used in electric, information, and communication fields (for example, the fields of mobile devices such as cellular phones, smartphones, lap-top computers, digital cameras, activity meters, arm computers, and electronic papers) in which a mobile device or the like is used, home and small-size industrial applications (for example, the fields of electric tools, golf carts, domestic and nursing care, and industrial robots), large-size industrial applications (for example, the fields of forklifts, elevators, harbor cranes), transportation system fields (for example, fields such as hybrid vehicles, electric vehicles, buses, trains, power-assisted bicycles, and electric motorcycles), electric power system applications (for example, fields such as various types of electric power generation, load conditioners, smart grids, general household installation-type power storage systems), medical applications (fields of medical devices such as earphone hearing aids), medical applications (fields such as dosage management systems), IoT fields, space and deep-sea applications (for example, fields such as spacecraft and submersible research vehicles), and the like.

### DESCRIPTION OF REFERENCE SYMBOLS

1: Positive electrode active material
2: First coating layer
3: Second coating layer
5: Positive electrode active material composite
10A: Positive electrode
10B: Negative electrode
11A: Positive electrode current collector
11B: Negative electrode current collector
12A: Positive electrode material layer
12B: Negative electrode material layer

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery including
a positive electrode active material composite including a positive electrode active material including an oxide containing Li and Co, and two or more coating layers at least partially covering the positive electrode active material, in which
the two or more coating layers include a first coating layer and a second coating layer from the positive electrode active material side toward the outside, one of the first coating layer and the second coating layer is composed of an Al element, and the other one of the first coating layer and the second coating layer includes at least one element selected from the group consisting of F, Mg, Mn, and Ti.

2. The secondary battery according to claim 1, wherein the positive electrode active material and the two or more coating layers are a fired body.

3. The secondary battery according to claim 1, wherein the positive electrode active material includes trivalent Co ions (Co3+).

4. The secondary battery according to claim 3, wherein the positive electrode active material includes Co3+ in an intermediate spin (IS) state.

5. The secondary battery according to claim 4, wherein the positive electrode active material further includes Co3+ in a low spin (LS) state, and a ratio of Co3+ in the intermediate spin (IS) state to Co3+ in the low spin (LS) state is 5% or more.

6. The secondary battery according to claim 1, wherein the other one of the first coating layer and the second coating layer includes F, Mg, and Mn elements.

7. The secondary battery according to claim 6, wherein the first coating layer includes F, Mg, and Mn elements, and the second coating layer is composed of the Al element.

8. The secondary battery according to claim 1, wherein the second coating layer includes Ti, Mg, and Mn elements.

9. The secondary battery according claim 1, wherein at least one of the first coating layer and the second coating layer has an oxide form of a constituent element.

10. The secondary battery according to claim 1, further comprising an electrolyte solution.
